(19) United States
(12) Patent Application Publication
(10) Pub. No.: US 2008/0115802 A1
(43) Pub. Date: May 22, 2008

(54) Cleaning method for improving wafer surface polluted by metal ions

(76) Inventors: Rey-Hsing Chiang, Shanghai (CN); Raulor Guo, Shanghai (CN); Chen-Tsung Huang, Shanghai (CN); Frank Liao, Shanghai (CN); Mark Liu, Shanghai (CN); Ruijing Han, Shanghai (CN); Jason Yan, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/603,211

(22) Filed: Nov. 22, 2006

(51) Int. Cl. B08B 7/00; C23F 1/00

(52) U.S. Cl. 134/3; 137/15.01

(57) ABSTRACT

A cleaning method for improving a wafer surface polluted by metal ions is disclosed. This method is to install an ion change filter in a pipeline, in which deionized water runs, to reduce the number of metal ions to be less than 0.1 ppb, so as to avoid that the metal ions of deionized water remains on the surface of the wafer during the process in cleaning the wafer and diffuses in the thermal oxidation process afterwards to affect the quality of oxide film.

### BACKGROUND OF THE INVENTION

1. Field of the Invention

This present invention relates a method to improve the situation of a wafer being polluted, and more particularly to a cleaning method for improving the wafer surface polluted by metal ions.

2. Description of the Related Art

With the progress of the semiconductor technology, the number of components on per unit area of a wafer increases according to Moore's law. However, the density distribution of transistors becomes higher and higher, and the size of components becomes smaller and smaller. Therefore, any error control happening in the manufacturing process will make a serious impact on the yield.

For growing the high quality of an oxide film, it is necessary to control the polluted metal well. For instance, in the current technology, before growing the gate oxide layer, a wafer has to be cleaned first by HF/deionized water (DI). Then, implement a RCA clean, which uses deionized water as a mixture, to remove the organic contaminant, oxide film and impurity particles attached to the surface of the wafer, so as to avoid that the contaminant on the wafer surface forms defects on growing the gate oxide layer afterwards to make the transistor lifetime short.

From the above-mentioned cleaning way, the content of metal ions in the so-called deionized water is commonly larger than or near 1.0 ppb. However, from the experiments or experience, discovering that use the deionized water and increase the deionized-water flowing speed for desiring to obtain the better effects in removing impurities will lead the problem, that metal ions attach to the oxide film of the wafer. This is because metal ions are with positive charges, and the surface of oxide film of a wafer is with negative charges, and consequently a stronger attraction exists between these two objects. When the surface of a wafer is cleaned by deionized water at a higher speed, the boundary thickness between the wafer and the current becomes thinner. Hence, metal ions more easily diffuse to the surface of the wafer. When the surface of the wafer catches excessive metal ions, the quality of a gate oxide film formed afterwards will not satisfy the demands. This easily makes components formed later have the leakage current, low yield and poor reliability.

Therefore, the present invention proposes a cleaning method for improving the wafer surface polluted by metal ions to solve the above-mentioned problems.

### SUMMARY OF THE INVENTION

The primary objective of the present invention is to provide a cleaning method for improving the wafer surface polluted by metal ions, which can make the better quality of a gate oxide film.

Another objective of the present invention is to provide a cleaning method for improving the wafer surface polluted by metal ions, which can avoid the leakage current caused by the defects of a gate oxide film, and raise the yield and the device reliability.

To achieve the above objectives, the present invention proposes a cleaning method for improving the wafer surface polluted by metal ions. The deionized water injects into a wafer bath through a pipeline, and an ion exchange filter is installed in this pipeline to substantially reduce the metal ion concentration of deionized water.

To enable the objectives, technical contents, characteristics, and accomplishments of the present invention to be easily understood, the embodiments of the present invention are to be described in detail in cooperation with the attached drawings below.

### BRIEF DESCRIPTION OF THE DRAWINGS

FIG. 1 is a diagram showing an embodiment according to the present invention.

FIG. 2 is a MCLT map of oxide film of a wafer surface cleaned by deionized water of the conventional method.

FIG. 3 is a MCLT map of oxide film of a wafer surface cleaned by deionized water of the present invention.

### DETAILED DESCRIPTION OF THE INVENTION

This invention relates to a cleaning method for improving a wafer surface polluted by metal ions, which can avoid that metal ions of deionized water affect the quality of the gate oxide film, and consequently avoid each device problem caused by the defects of the gate oxide film.

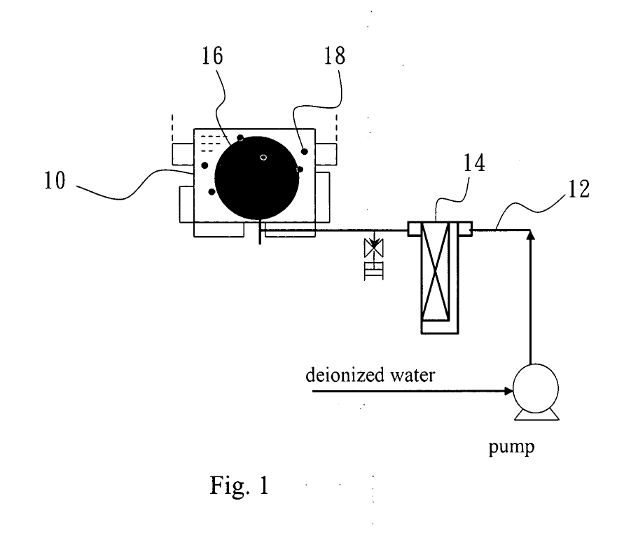

From the foregoing, the metal ions contained within the deionized water will attach to a surface of a wafer. This will make the surface quality of a gate oxide film formed afterwards poor. Hence, refer to FIG. 1, which is a diagram illustrating an embodiment according to the present invention. Before deionized water injects into a wafer bath through a pipeline 12, this invention installs an ion exchange filter 14 in the pipeline 12 to decrease the number of metal ions 18 of deionized water from above/near 1.0 ppb to below 0.1 ppb, so as to make ultra-clean deionized water.

Afterwards, make a clean process on a wafer 16 by using ultra-clean deionized water which is obtained from the ion exchange filter 14. First, put the wafer 16, on which a gate oxide film will be formed, into a wafer bath 10, and then clean the surface of the wafer 16 by HF/ultra-clean deionized water obtained from the ion exchange filter 14. Then, use the ultra-clean deionized water obtained from the ion exchange filter 14 as a mixture to perform a RCA clean, whose common steps are as the following:

First, use the clean liquid composed of NH3, H₂O₂, and ultra-clean deionized water to immerse the wafer 16 for 10˜20 minutes at 75˜85° C. to remove the organic spots and the particles attached to the wafer 16, wherein the volume ratio of NH3, H₂O₂, and ultra-clean is 1:1˜2:5˜7. Then, use diluted HF mixed with ultra-clean deionized water at a room temperature to immerse the wafer 16 for several seconds to remove the silicon oxide film of the surface of the wafer 16. At last, use the clean liquid composed of HCl, H₂O₂, and ultra-clean deionized water to immerse the wafer 16 for 10˜20 minutes at 78˜85° C. to remove the metal impurities of the surface of the wafer 16, wherein the volume ratio of HCl, H₂O₂, and ultra-clean is 1:1˜2:5˜7. After completing the RCA clean, perform the last clean process on the surface of the wafer 16 by ultra-clean deionized water again to finish all the whole clean process. Then, move the wafer 16 to an oxidation furnace, so as to form a gate oxide film.

Of course, the wafer 16 could be baked after cleaning, but this part is not the characteristic of the present invention, so it is not stated here again.

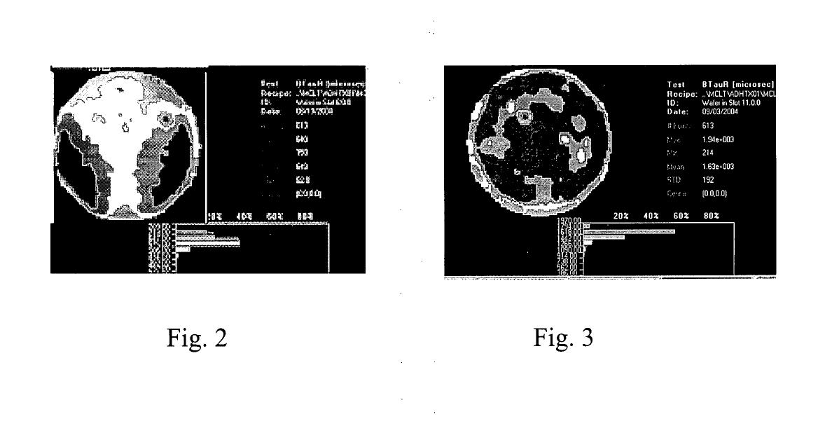

The following is to make an observation on a MCLT (minority carrier lifetime) map of a wafer cleaned by the current deionized water without through any filter and on that of a wafer cleaned by ultra-clean deionized water. A MCLT map is an illustration to observe the yield of the oxide, wherein the results are shown in FIG. 2 and FIG. 3. FIG. 2 is a MCLT map of a wafer cleaned by the common deionized water, and FIG. 3 is a MCLT map of a wafer cleaned by ultra-clean deionized water.

From FIG. 2 and FIG. 3, it is obvious to find that compared with the conventional method to clean the wafer surface by deionized water, the present invention to clean the wafer surface by ultra-clean deionized water obtained from the installed ion exchange filter are able to substantially reduce the residual of metal ions. Consequently, the quality of the gate oxide film formed afterwards and the yield are raised greatly, and then the reliability is raised.

In summary, the present invention is a cleaning method for improving a wafer surface polluted by metal ions, which installs an ion exchange filter in a pipeline in which deionized water runs, so as to effectively reduce the content of metal ions within the deionized water, and thus prevents the oxide film produced when the wafer surface is cleaned by deionized water and the metal ions diffuse into the wafer surface.

Those described above are only the preferred embodiments to clarify the technical contents and characteristics of the present invention to enable the persons skilled in the art to understand, make and use the present invention. However, it is not intended to limit the scope of the present invention. Any modification and variation according to the spirit of the present invention is to be also included within the scope of the claims of the present invention.

What is claimed is:

1. A cleaning method for improving a wafer surface polluted by metal ions, which installs at least one ion exchange filter in a pipeline which supplies deionized water to a wafer bath and then implements a clean process on a wafer by said deionized water that has been through said ion exchange filter to reduce metal ions within said deionized water to diffuse on the surface of said wafer.

2. The cleaning method for improving a wafer surface polluted by metal ions according to claim 1, wherein the concentration of said metal ions is less than 0.1 ppb.

3. The cleaning method for improving a wafer surface polluted by metal ions according to claim 1, wherein said clean process includes a HF/deionized water clean and a RCA clean.

4. A cleaning method for improving a wafer surface polluted by metal ions, comprising the steps of:
placing at least one wafer waiting to be cleaned in a wafer bath;
cleaning said wafer by diluted HF;
cleaning said wafer by deionized water whose metal ion concentration is less than 0.1 ppb; and
implementing a RCA clean process on said wafer.

5. The cleaning method for improving a wafer surface polluted by metal ions according to claim 4, wherein said deionized water is manufactured by at least one ion exchange filter installed in a pipeline for conducting said deionized water.
